(19) United States
(12) Patent Application Publication
(10) Pub. No.: US 2019/0347559 A1
(43) Pub. Date: Nov. 14, 2019

(54) INPUT PROCESSING METHOD USING NEURAL NETWORK COMPUTATION, AND APPARATUS THEREFOR

(71) Applicant: Samsung Electronics Co., Ltd., Gyeonggi-do (KR)

(72) Inventors: Byoung Ik KANG, Seoul (KR); Gil Yoon KIM, Gyeonggi-do (KR); Sung Kyu LEE, Gyeonggi-do (KR)

(21) Appl. No.: 16/464,724

(22) PCT Filed: Dec. 26, 2017
(86) PCT No.: PCT/KR2017/015499

§ 371 Date: May 29, 2019

(30) Foreign Application Priority Data
Dec. 27, 2016 (KR) 10-2016-0179854

(51) Int. Cl. G06N 3/10; G06N 3/04

(52) U.S. Cl. CPC G06N 3/10; G06N 3/04

(57) ABSTRACT

Disclosed is an electronic device. The electronic device includes a first calculation unit performing one neural network operation of a plurality of neural network operations, a second calculation unit including a hardware accelerator performing a specified neural network operation, and an interface controller connected between the first calculation unit and the second calculation unit. Moreover, various embodiment found through the disclosure are possible.

### TECHNICAL FIELD

Embodiments disclosed in the disclosure relate to a technology for processing input data using a neural network operation.

### BACKGROUND ART

As the application field of machine learning has been expanded, various neural network structures have been proposed recently. The neural network structures that utilize not only the result of the final stage but also information of the intermediate stage have also been studied because information available for each layer is different. Furthermore, the types of neural networks may be different for each application field, and two or more heterogeneous neural networks may be used at the same time. The operation results of the heterogeneous neural network operation may be used independently depending on the application field or may have an order and may affect each other.

In the field of machine learning, the dedicated hardware design has been studied to improve the computational efficiency of neural network operation and to reduce memory usage. As various neural network operations such as heterogeneous network operations have been proposed, various algorithms for a neural network operation have been developed.

### DISCLOSURE

### Technical Problem

Because the hardware designed for conventional neural network operations accelerates simple operations, there is a limit to coping with various neural network structures. When the information of a layer intermediate stage is controlled or utilized, the processing speed may be reduced due to flexibility constraints. Because a neural network model occupies about several hundred MB when only the hardware designed for the conventional neural network operation is used, the size of a system on chip (SOC) may increase when various neural network operations are required. Moreover, because the large amount of memory capacity is needed for the neural network operation, even though both a neural network operation device performing an operation according to software and hardware designed to perform a specific neural network operation are used, a local memory capacity is several hundred KB or more. Even in the case of increasing the local memory capacity, the capacity of SoC may increase. When an external memory is applied to share the data of a layer intermediate stage, the processing speed may be reduced.

Various embodiments disclosed in the disclosure may provide a new system and an operating method that solve the problem of hardware performing the above-described conventional neural network operation and guarantee a flexible neural network operation even in a limited system environment.

### Technical Solution

According to an embodiment disclosed in the disclosure, an electronic device may include a first calculation unit performing one neural network operation of a plurality of neural network operations, a second calculation unit including a hardware accelerator performing a specified neural network operation, and an interface controller connected between the first calculation unit and the second calculation unit.

According to another embodiment disclosed in the disclosure, an electronic device may include a system on chip (SoC) and a first memory electrically connected to the SoC. The SoC may include at least one processor, a core performing one neural network operation of a plurality of neural network operations, a hardware accelerator performing a specified neural network operation, a second memory for storing a neural network operation result of the core, a third memory for storing a neural network operation result of the hardware accelerator, and an interface controller connected between the second memory and the third memory.

Furthermore, according to another embodiment disclosed in the disclosure, a method may include determining at least one calculation unit performing a neural network operation on input data by using common hardware among a first calculation unit performing a plurality of neural network operations or a second calculation unit including a hardware accelerator performing a specified neural network operation and performing a neural network operation on the input data, using the determined at least one calculation unit.

### Advantageous Effects

According to various embodiments of the disclosure, various neural network operations may be performed using a small system space.

According to various embodiments of the disclosure, the neural network operation may be flexibly performed depending on various situations.

Besides, a variety of effects directly or indirectly understood through this disclosure may be provided.

### DESCRIPTION OF DRAWINGS

FIG. 1 is a block diagram illustrating a configuration of an electronic device performing a neural network operation, according to an embodiment.

FIG. 2 is a block diagram illustrating a configuration of an electronic device performing a neural network operation, according to another embodiment.

FIG. 3 is a block diagram illustrating a configuration of an electronic device performing a neural network operation, according to still another embodiment.

FIG. 4 illustrates an electronic device in a network environment, according to various embodiments.

FIG. 5 is a view illustrating a block diagram of an electronic device according to an embodiment.

### MODE FOR INVENTION

Hereinafter, various embodiments of the disclosure may be described with reference to accompanying drawings. Accordingly, those of ordinary skill in the art will recognize that modification, equivalent, and/or alternative on the various embodiments described herein can be variously made without departing from the scope and spirit of the disclosure. With regard to description of drawings, similar components may be marked by similar reference numerals.

In the disclosure, the expressions “have”, “may have”, “include” and “comprise”, or “may include” and “may comprise” used herein indicate existence of corresponding features (e.g., components such as numeric values, functions, operations, or parts) but do not exclude presence of additional features.

In the disclosure, the expressions “A or B”, “at least one of A or/and B”, or “one or more of A or/and B”, and the like may include any and all combinations of one or more of the associated listed items. For example, the term “A or B”, “at least one of A and B”, or “at least one of A or B” may refer to all of the case (1) where at least one A is included, the case (7) where at least one B is included, or the case (3) where both of at least one A and at least one B are included.

The terms, such as “first”, “second”, and the like used in the disclosure may be used to refer to various components regardless of the order and/or the priority and to distinguish the relevant components from other components, but do not limit the components. For example, “a first user device” and “a second user device” indicate different user devices regardless of the order or priority. For example, without departing from the scope of the disclosure, a first component may be referred to as a second component, and similarly, a second component may be referred to as a first component.

It will be understood that when an component (e.g., a first component) is referred to as being “(operatively or communicatively) coupled with/to” or “connected to” another component (e.g., a second component), it may be directly coupled with/to or connected to the other component or an intervening component (e.g., a third component) may be present. In contrast, when an component (e.g., a first component) is referred to as being “directly coupled with/to” or “directly connected to” another component (e.g., a second component), it should be understood that there are no intervening component (e.g., a third component).

According to the situation, the expression “configured to” used in the disclosure may be used as, for example, the expression “suitable for”, “having the capacity to”, “designed to”, “adapted to”, “made to”, or “capable of”. The term “configured to” must not mean only “specifically designed to” in hardware. Instead, the expression “a device configured to” may mean that the device is “capable of” operating together with another device or other parts. For example, a “processor configured to (or set to) perform A, B, and C” may mean a dedicated processor (e.g., an embedded processor) for performing a corresponding operation or a generic-purpose processor (e.g., a central processing unit (CPU) or an application processor) which performs corresponding operations by executing one or more software programs which are stored in a memory device.

Terms used in the disclosure are used to describe specified embodiments and are not intended to limit the scope of the disclosure. The terms of a singular form may include plural forms unless otherwise specified. All the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal unless expressly so defined in various embodiments of the disclosure. In some cases, even if terms are terms which are defined in the disclosure, they may not be interpreted to exclude embodiments of the disclosure.

An electronic device according to various embodiments of the disclosure may include at least one of, for example, smartphones, tablet personal computers (PCs), mobile phones, video telephones, electronic book readers, desktop PCs, laptop PCs, netbook computers, workstations, servers, personal digital assistants (PDAs), portable multimedia players (PMPs), Motion Picture Experts Group (MPEG-1 or MPEG-2) Audio Layer 3 (MP3) players, mobile medical devices, cameras, or wearable devices. According to various embodiments, the wearable device may include at least one of an accessory type (e.g., watches, rings, bracelets, anklets, necklaces, glasses, contact lens, or head-mounted-devices (HMDs), a fabric or garment-integrated type (e.g., an electronic apparel), a body-attached type (e.g., a skin pad or tattoos), or a bio-implantable type (e.g., an implantable circuit).

According to various embodiments, the electronic device may be a home appliance. The home appliances may include at least one of, for example, televisions (TVs), digital versatile disc (DVD) players, audios, refrigerators, air conditioners, cleaners, ovens, microwave ovens, washing machines, air cleaners, set-top boxes, home automation control panels, security control panels, TV boxes (e.g., Samsung HomeSync™, Apple TV™, or Google TV™), game consoles (e.g., Xbox™ or PlayStation™), electronic dictionaries, electronic keys, camcorders, electronic picture frames, and the like.

According to another embodiment, an electronic device may include at least one of various medical devices (e.g., various portable medical measurement devices (e.g., a blood glucose monitoring device, a heartbeat measuring device, a blood pressure measuring device, a body temperature measuring device, and the like), a magnetic resonance angiography (MRA), a magnetic resonance imaging (MRI), a computed tomography (CT), scanners, and ultrasonic devices), navigation devices, Global Navigation Satellite System (GNSS), event data recorders (EDRs), flight data recorders (FDRs), vehicle infotainment devices, electronic equipment for vessels (e.g., navigation systems and gyrocompasses), avionics, security devices, head units for vehicles, industrial or home robots, automated teller machines (ATMs), points of sales (POSs) of stores, or internet of things (e.g., light bulbs, various sensors, electric or gas meters, sprinkler devices, fire alarms, thermostats, street lamps, toasters, exercise equipment, hot water tanks, heaters, boilers, and the like).

According to an embodiment, the electronic device may include at least one of parts of furniture or buildings/structures, electronic boards, electronic signature receiving devices, projectors, or various measuring instruments (e.g., water meters, electricity meters, gas meters, or wave meters, and the like). According to various embodiments, the electronic device may be one of the above-described devices or a combination thereof. An electronic device according to an embodiment may be a flexible electronic device. Furthermore, an electronic device according to an embodiment of the disclosure may not be limited to the above-described electronic devices and may include other electronic devices and new electronic devices according to the development of technologies.

Hereinafter, electronic devices according to various embodiments will be described with reference to the accompanying drawings. In the disclosure, the term “user” may refer to a person who uses an electronic device or may refer to a device (e.g., an artificial intelligence electronic device) that uses the electronic device.

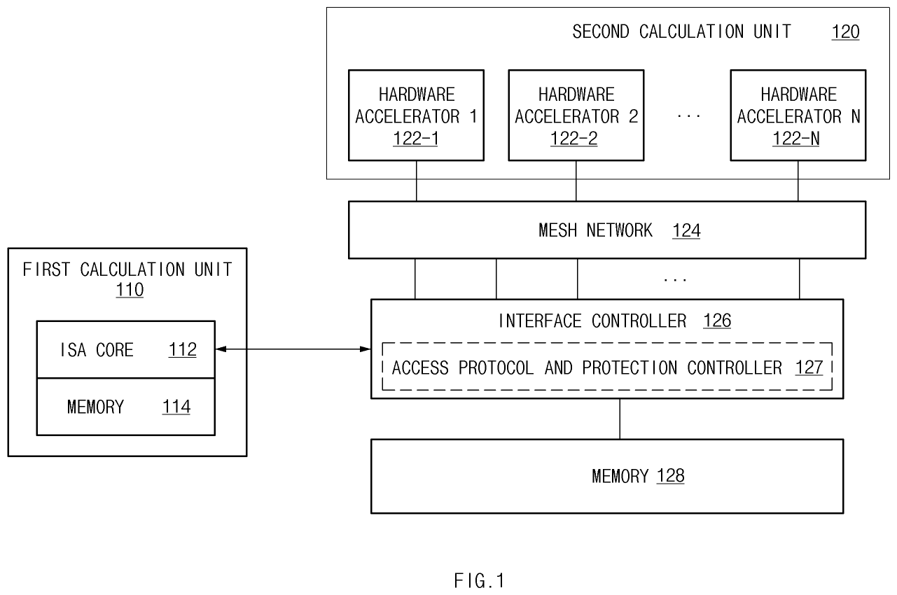

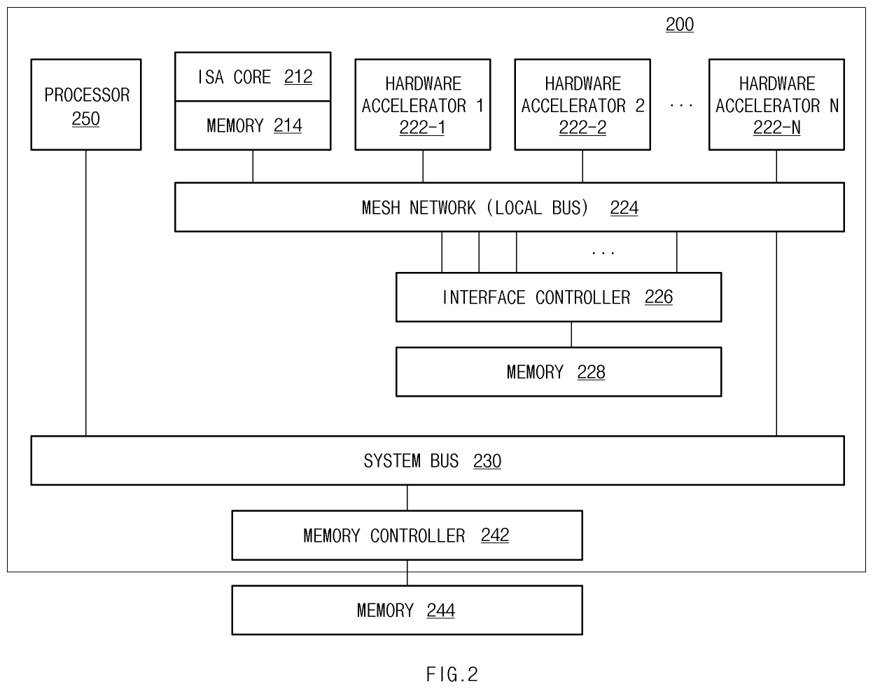

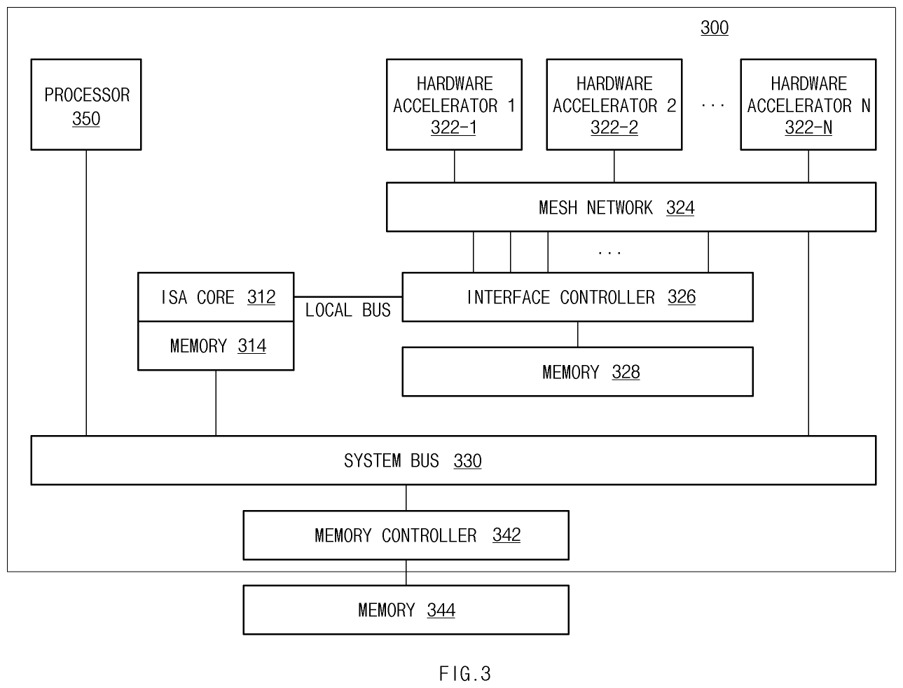

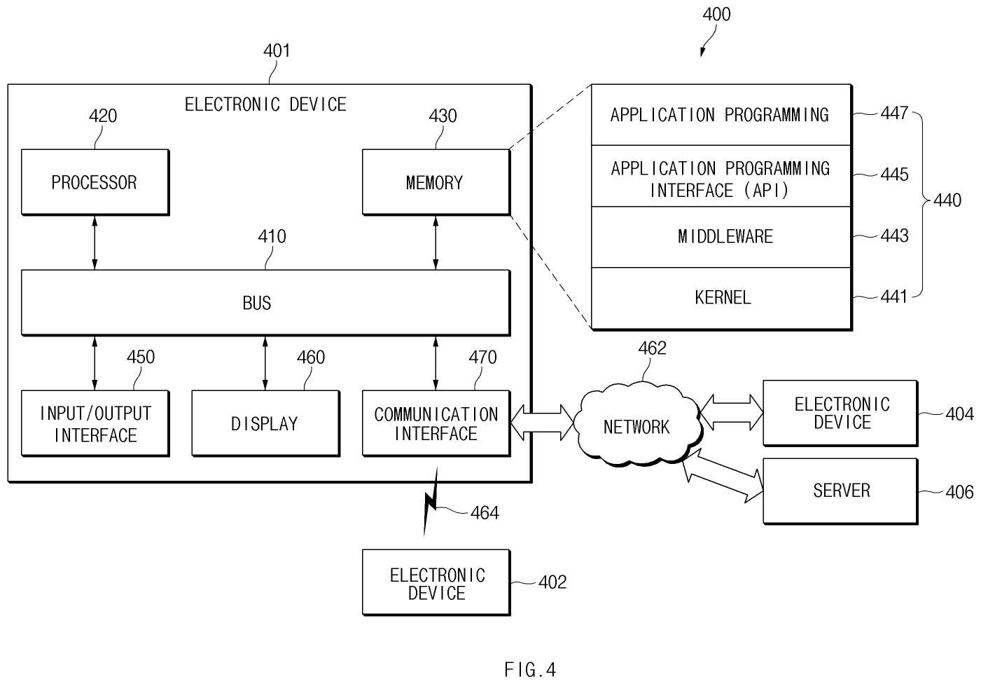

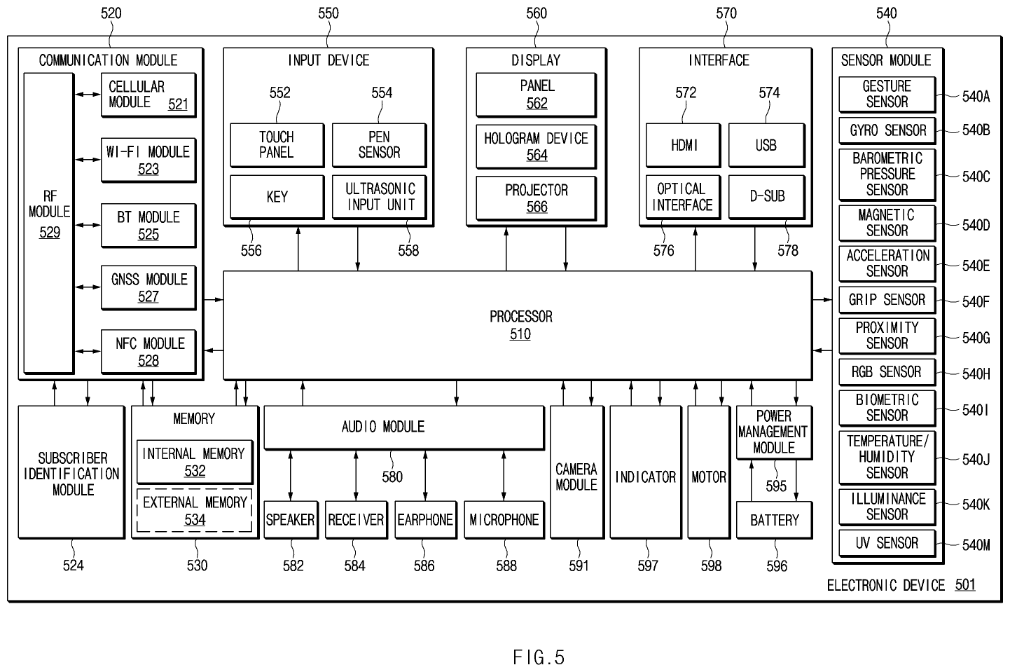

An electronic device according to an embodiment may include an instruction set architecture (ISA) core and a neural network operator including a hardware accelerator. For example, referring to FIG. 1, an electronic device may include a first calculation unit 110 including an ISA core 112 and/or a second calculation unit 120 including a hardware accelerator. The configuration of the electronic device illustrated in FIG. 1 is only an example and is variously changed to implement various embodiments disclosed in the disclosure. For example, the electronic device may include configurations the same as configurations such as the electronic devices of FIGS. 2 to 3, a user terminal 401 illustrated in FIG. 4, and an electronic device 501 illustrated in FIG. 5 or may be properly changed using the configurations.

The first calculation unit 110 may perform a plurality of neural network operations by using common hardware. The first calculation unit 110 may perform operations corresponding to various neural network structures depending on a predetermined instruction set. The first calculation unit 110 may process the information of a layer intermediate stage. The first calculation unit 110 may control the neural network operation of the second calculation unit 120. The first calculation unit 110 may include the ISA core 112 and/or a memory 114.

The ISA core 112 may be an essential element for a central processing unit (CPU) or a processor to operate. The ISA core 112 may correspond to the processor. In an embodiment, the ISA core 112 may be a part of the processor. The ISA core 112 may indicate a logic block positioned on an integrated circuit capable of maintaining an independent architectural state.

The ISA may indicate the structure of an instruction set or a method for processing instructions. The ISA may indicate an instruction that a processor or the ISA core 112 is capable of understanding. The ISA may be an abstracted interface between hardware and lower level software. The ISA may be positioned at the layer between operating system (OS) and hardware to help communication with each other. The instruction set structure may be part of a programming-related computer architecture including data types, instructions, registers, addressing mode, memory structures, exception handling, or external input/output. The ISA may variously define an arithmetic type, an operand type, the number of registers, an encoding method, and the like. Each of the instructions that the processor understands may be referred to as an instruction. A processor such as a digital signal processor (DSP) or a graphic processing unit (GPU) may implement a specific ISA. Different types of OSs may be executed on the processor designed depending on different ISAs.

The ISA core 112 may be a core designed depending on a specific ISA type. For example, the ISA core 112 may be a complex instruction set computer (CISC) core or a reduced instruction set computer (RISC) core. The ISA core 112 is associated with the ISA, which defines the executable instructions in the processor. The ISA core 112 may perform an operation of a pipeline to recognize the instructions and to process the instructions as the instructions is defined by the ISA.

The ISA core 112 may perform an execution cycle or an extraction cycle. The pipeline may be an operation of fetching another instruction from a memory while a single instruction is being executed in a process by overlapping the execution cycle and the extraction cycle. The pipeline may be a method that divides a single instruction into a plurality of processing units and then processes the plurality of processing units in parallel to speed up the processing speed of the processor. The instruction pipeline may be expanded to include another processor cycle. The instruction pipeline may be configured using a first in first out (FIFO) buffer having the nature of a queue. According to various embodiments, the processor may include one or more ISA cores (e.g., 112). The processor may include a microprocessor, an embedded processor, a DSP, a network processor, or any processor executing codes.

The ISA core 112 may perform profiling to efficiently utilize the neural network operation. When operating at least one neural network, the ISA core 112 may perform profiling before the operation. The ISA core 112 may analyze the feature of a neural network. The ISA core 112 may store the feature of the analyzed neural network as meta data. The ISA core 112 may load the meta data or commands onto each calculation unit (110, 120). The ISA core 112 may perform scheduling to control the calculation of the ISA core 112 and the start and end of at least one hardware accelerator (122-1, 122-2, . . . , and 122-N). The ISA core 112 may perform loading, scheduling, or the like through application programming interface (API).

The ISA core 112 may use the profiling result to determine a time point of synchronization between calculation units and to schedule each neural network. The ISA core 112 may control the operation of the second calculation unit 120, using the profiling result. The ISA core 112 may generate a signal or an instruction for controlling the operation of the second calculation unit 120. At least part of the functions of the ISA core 112 may be performed by another component. For example, the profiling of the neural network may be performed by an interface controller 126, a processor 250 of FIG. 2, or a processor 350 of FIG. 3.

In an embodiment, the meta data may include information such as the type of the corresponding neural network, the number of layers, the calculation unit (e.g., 110 or 120) suitable for each computation, the expected calculation time, the data sharing form between calculation units, the data sharing point between calculation units, a neural network model, and/or a data compression method. In an embodiment, two or more neural networks may operate. In this case, the meta data may include information about the calculation unit to be operated, a scheduling and/or synchronization method, a calculation result sharing form, a calculation result sharing time point, and/or a calculation result integration method.

In an embodiment, the ISA core 112 may determine a memory for storing the calculation result among the memory 114 or a memory 128. The ISA core 112 may allow a memory, in where a memory space remains, from among the memory 114 or the memory 128 to store the calculation result.

The memory 114 may store the calculation result of the first calculation unit 110. In an embodiment, the memory 114 may store the calculation result of the second calculation unit 120. The calculation result may include the result of an intermediate layer of the neural network operation and the result of the output layer. The result of an intermediate layer may be the calculation result of a hidden layer. The result of an intermediate layer may include at least one of pixel values of the hidden layer. The memory 114 may transfer the stored information to the ISA core 112. The information stored in the memory 114 may be shared with an external device (e.g., a hardware accelerator 1 122-1) via the interface controller 126. In an embodiment, the memory 114 may be a cache memory, a buffer memory, or a local memory. In an embodiment, the memory 114 may be a static random access memory (SRAM). The memory 114 may store meta data according to the embodiments described in the disclosure. In an embodiment, the memory 114 may include a scratch pad and/or a circular buffer.

The second calculation unit 120 may include hardware accelerators 1, 2, . . . , and N 122-1, 122-2, . . . , and 122-N. The second calculation unit 120 may include a hardware accelerator configured to perform a specified neural network operation. Different hardware accelerators (e.g., 122-1 and 122-2) may perform heterogeneous neural network operations.

The at least one hardware accelerator 122-1, 122-2, . . . , or 122-N may be a hardware configuration that performs a part of functions of an electronic device. The at least one hardware accelerator 122-1, 122-2, . . . , or 122-N may perform a part of functions of an electronic device quickly compared with a software method implemented by a specific processor (e.g., CPU). For example, at least one of the hardware accelerators 122-1, 122-2, . . . , and 122-N may include at least one of a CPU, a GPU, a DSP or an ISA, a graphic card, or a video card.

The processing speed of the at least one hardware accelerator 122-1, 122-2, . . . , or 122-N may be fast compared with the case where the same function is implemented by software. The plurality of hardware accelerators 122-1, 122-2, . . . , and 122-N may perform the neural network operation at the same time.

The interface controller 126 may relay a resource request or transfer from one component to another component. The interface controller 126 may relay the resource request of a client (e.g., the first calculation unit 110, the ISA core 112, or the second calculation unit 120). The interface controller 126 may transfer a processing request of input data to the first calculation unit 110 and/or the second calculation unit 120. In an embodiment, when obtaining a calculation request of a specific hardware accelerator (e.g., 122-1) from the first calculation unit 110, the interface controller 126 may transfer the calculation request to the specific hardware accelerator.

The interface controller 126 may make a request for calculation to the first calculation unit 110 and/or the second calculation unit 120. The interface controller 126 may determine a calculation unit suitable for the processing of input data. For example, when there is no hardware accelerator suitable for the input data among the at least one hardware accelerator 122-1, 122-2, . . . , or 122-N, the interface controller 126 may make a request for the processing of the input data to the first calculation unit 110.

The interface controller 126 may perform protocol conversion, flow control, or the like to share the local memory (e.g., 114 or 128) of each calculation unit (110 or 120). The interface controller 126 may use the memory in another calculation unit without needing to control the memory via software. The interface controller 126 may perform compression or decompression to reduce the size upon transmitting or receiving data.

The interface controller 126 may include an access protocol (e.g., AXI, OCP, Mesh, or the like) and/or a protection controller 127. The interface controller 126 may make a request for the processing of the input data to the ISA core 112 or the at least one hardware accelerator 122-1, 122-2, . . . , or 122-N depending on the access protocol 127. The interface controller 126 may convert the signal, information, or instruction of the first calculation unit 110 to the signal, information, or instruction of the type that the second calculation unit 120 can read. The interface controller 126 may convert the information generated by the second calculation unit 120 or the stored information to the information of the type that the first calculation unit 110 can read.

The interface controller 126 may include the protection controller 127 for the calculation of a specific purpose (e.g., face recognition, iris recognition, or the like).

In an embodiment, when security is required, such as the case where a neural network operation is used for user authentication, the interface controller 126 may use the protection controller 127. The interface controller 126 may allow an electronic device to use at least part of the components (e.g., the first calculation unit and the second calculation unit) described in the disclosure or the functions performed by the component described in the disclosure, only when authorization is granted through the normal path. In an embodiment, the electronic device may access data that requires security in the protected area of the electronic device.

In an embodiment, the interface controller 126 may be positioned in the first calculation unit 110 or the second calculation unit 120. In another embodiment, the interface controller 126 may be positioned at a place at which the first calculation unit 110 or the second calculation unit 120 is capable of being connected. In an embodiment, the interface controller 126 may be referred to as a “relay circuit” or a “proxy circuit”.

The interface controller 126 may be connected to the first calculation unit 110 and the second calculation unit 120. The interface controller 126 may connect the second calculation unit 120 to a second memory. In an embodiment, the interface controller 126 may be connected to the first calculation unit 110 and the second calculation unit 120 via a local bus. The interface controller 126 may connect the second calculation unit 120 to the second memory via the local bus. The interface controller 126 may connect the first calculation unit 110 to the second memory via the local bus.

The memory 128 may store the calculation result of the second calculation unit 120. In an embodiment, the memory 128 may store the calculation result of the first calculation unit 110. The calculation result may include the result of an intermediate layer, i.e., the result of the output layer. The memory 128 may store the calculation result of one or more hardware accelerators (e.g., 122-1) of the at least one hardware accelerator 122-1, 122-2, . . . , or 122-N. The memory 128 may transfer the stored information to the interface controller 126. The information stored in the memory 128 may be shared with an external device (e.g., the memory 114 of the first calculation unit 110) via the interface controller 126. In an embodiment, the memory 128 may be a cache memory, a buffer memory, or a local memory. In an embodiment, the memory 128 may be a static random access memory (SRAM). In an embodiment, the memory 128 may include a scratch pad and/or a circular buffer. The electronic device may share the information stored in the local memory, thereby improving system processing speed.

The mesh network 124 may mean a network in which network devices such as nodes and sensors can communicate with each other even though not being connected to a surrounding computer or a network hub. The first calculation unit 110 and the second calculation unit 120 may share a resource, a signal, or data with each other via the mesh network 124. The second calculation unit 120 may transfer or obtain a resource, a signal, or data to the interface controller 126 and/or the memory 128 via the mesh network 124.

In an embodiment, the second calculation unit 120 may further include an interface controller 126 and/or the memory 128. In an embodiment, the second calculation unit 120 may perform communication with each of components via the mesh network 124 performing a local connection.

Hereinafter, the operation of the electronic device according to an embodiment will be described with reference to FIG. 1.

In an embodiment, the electronic device may share information between the memory 114 of the first calculation unit 110 and the memory 128. In an embodiment, the memory 114 and the memory 128 may be local memories.

The interface controller 126 may refer to the calculation result of the first calculation unit 110 or the second calculation unit 120. The first calculation unit 110 may refer to the calculation result of the second calculation unit 120 or the calculation result stored in the memory 128 via the interface controller 126. The second calculation unit 120 may refer to the calculation result of the first calculation unit 110 or the calculation result stored in the memory 114 via the interface controller 126.

The electronic device may share data stored in the memory 114 and the memory 128, using the interface controller 126. In an embodiment, the interface controller 126 may convert a protocol for memory sharing. In an embodiment, the interface controller 126 may control a flow for memory sharing. In an embodiment, the interface controller 126 may compress and/or decompress data for memory sharing. The size of a system on chip (SoC) may be saved and the processing may be improved, through data sharing between memories based on the interface controller 126.

In an embodiment, the electronic device may transfer the data stored in the memory 114 to the memory 128 and/or a specific hardware accelerator (e.g., 122-1) via the interface controller 126. In an embodiment, the electronic device may transfer the data stored in the memory 128 to the memory 114 and/or the ISA core 112 through the interface controller 126. The electronic device may fetch data from the first calculation unit 110 through the interface controller 126 or may transfer the data to the first calculation unit 110 through the interface controller 126. The electronic device may fetch data from the second calculation unit 120 through the interface controller 126 or may transfer the data to the second calculation unit 120 through the interface controller 126.

In an embodiment, the electronic device may allocate a calculation unit or may share data, in consideration of the feature of a neural network. The electronic device may manage information for the allocation of a calculation unit and/or the sharing of data, as meta data.

The electronic device may perform profiling before performing a neural network operation. The electronic device may analyze the feature of the neural network and may store the feature of the neural network as meta data. The electronic device may determine a calculation unit suitable for the calculation of input data, using the meta data.

In an embodiment, the electronic device may determine that the first calculation unit 110 and/or the second calculation unit 120 is the suitable calculation unit. In an embodiment, the electronic device may determine that a specific hardware accelerator (e.g., 122-2) in the second calculation unit 120 is a suitable calculation unit.

In an embodiment, when the electronic device performs calculation using both the first calculation unit 110 and the second calculation unit 120, the electronic device may store and use information such as the time point of synchronization between the first calculation unit 110 and the second calculation unit 120, scheduling information, and/or a calculation result sharing form, as meta data. In an embodiment, when the electronic device uses a plurality of hardware accelerators of the second calculation unit 120, the electronic device may store and use information such as the time point of synchronization between the specific hardware accelerators, scheduling information, and/or a calculation result sharing form, as meta data. In an embodiment, the ISA core 112, a separate processor (e.g., the processor 250 of FIG. 2), and/or the interface controller 126 may generate the meta data.

In an embodiment, the first calculation unit 110, the second calculation unit 120, and/or the interface controller 126 may perform the following operations. The first calculation unit 110, the second calculation unit 120, and/or the interface controller 126 may allow the DSP to use data in a general form such as a raster order, by calculating the address of the memory storing the data for convolution of 4-division (4-D) form used in the deep neural network (DNN) to arrange the data. The DSP may support first input first output (FIFO). In an embodiment, the first calculation unit 110, the second calculation unit 120, and/or the interface controller 126 may read out the DNN filter coefficient stored in the form of a sparse matrix, in which the number of bits is reduced or which is compressed, and then may transmit the DNN filter coefficient to the ISA core 112.

In an embodiment, the electronic device may perform a pipeline operation utilizing machine learning. For example, an image processing pipeline operation will be described.

The operation according to the image processing pipeline may include pre-processing, region of interest (ROI) selecting, precise modeling of ROI, and decision making.

In an embodiment, the signal pre-processing such as noise removal, color space conversion, image scaling, and/or Gaussian pyramid may be performed by an image signal processor (ISP). The ISP may be referred to as a “camera calculation unit”.

In an embodiment, the first calculation unit 110, the second calculation unit 120 and/or the interface controller 126 may perform ROI selecting including object detection, background subtraction, feature extraction, image segmentation, and/or a labeling algorithm (e.g., connected-component labeling).

In an embodiment, the first calculation unit 110, the second calculation unit 120, and/or the interface controller 126 may perform the precise modeling of ROI including object recognition, tracking, feature matching, and/or gesture recognition. The ROI selecting and the precise modeling of ROI may correspond to image processing and a neural network operation.

In an embodiment, the first calculation unit 110, the second calculation unit 120 and/or the interface controller 126 may perform the decision making that performs motion analysis, matching determination (e.g., match/no match) or decides a flag event. The decision making may be referred to as vision and control processing.

In the image processing pipeline, the first calculation unit 110, the second calculation unit 120 and/or the interface controller 126 may perform ROI processing such as object detection, object recognition, and/or object tracking. In an embodiment, the first calculation unit 110, the second calculation unit 120, and/or the interface controller 126 may perform determination based on the ROI processing result. The first calculation unit 110, the second calculation unit 120 and/or the interface controller 126 may perform the determination such as motion, matching, or the like. In an embodiment, each of the above-described operations may be performed by the ISA core 112 and/or a hardware accelerator (e.g., 122-1).

Hereinafter, the operation of the electronic device simultaneously using object tracking and object recognition will be described.

The first calculation unit 110 and/or the interface controller 126 may analyze workload through profiling of a neural network for object tracking and object recognition. In an embodiment, the ISA core 112 of the first calculation unit 110 and/or the interface controller 126 may generate meta data through profiling. The ISA core 112 and/or the interface controller 126 may generate the meta data based on the workload analysis.

The first calculation unit 110 and/or the interface controller 126 may allocate a neural network to be processed by each of the first calculation unit 110 and/or the second calculation unit 120, using the meta data. The first calculation unit 110 and/or the interface controller 126 may set a memory sharing method for sharing each neural network operation result, or the like.

The first calculation unit 110 and/or the interface controller 126 may receive the pre-processed image from the ISP (e.g., a camera calculation unit).

Hereinafter, the pre-processed image may be referred to as “input data”. The memory 114 and/or the memory 128 may store the input data. Herein, the memory 114 and/or the memory 128 may be a local memory. In an embodiment, the memory 114 may store the input data. The second calculation unit 120 may obtain the input data stored in the memory 114, through the interface controller 126. In another embodiment, the memory 128 may store the input data, and the interface controller 126 may transfer the input data stored in the memory 128 to the first calculation unit 110. In still another embodiment, the input data may be stored in a memory, in which memory space remains, from among the memory 114 or the memory 128.

The first calculation unit 110 may perform the allocated neural network operation. The second calculation unit 120 may perform the allocated neural network operation. The neural network operation may be simultaneously or continuously performed by each calculation unit. For example, the first calculation unit 110 may perform object tracking, and the second calculation unit 120 may perform object recognition.

The calculation result or processing result of the first calculation unit 110 may be stored in the memory 114. The calculation result or processing result of the second calculation unit 120 may be stored in the memory 128. The calculation result or processing result stored in the memory 114 or 128 may be shared with each other.

In an embodiment, the first calculation unit 110 may perform final determination (e.g., determination of an operation according to the image recognition result or the image recognition result) on the input data. The final determination for the input data may be performed by the processor 250 or 350 (e.g., CPU) of FIG. 2 or 3.

In an embodiment, the first calculation unit 110 may transfer the result of the final determination to an upper system such as a processor (e.g., CPU). In an embodiment, the first calculation unit 110 may control a system to perform an operation according to the result of the final determination. The ISA corresponding to the first calculation unit 110 may include an instruction that makes it possible to perform an operation according to the result of the final determination and/or an instruction that can control the system

When various neural network operations are performed depending on software, the efficiency of calculation may be reduced; in the case of corresponding to various pieces of hardware, it may be difficult to perform calculation depending on the change of an algorithm. In the case of adding hardware for various neural network operations, the size of SoC may increase and the cost may rise. According to various embodiments disclosed in the disclosure, the efficiency of calculation may increase using hardware designed to perform a specific neural network operation; the flexibility of calculation may increase using a device operating depending on software to perform the various neural network operations.

According to an embodiment, a local memory of each calculation unit may be shared, thereby reducing the size of SoC and preventing the bottleneck according to memory input/output. According to an embodiment, the size of SoC may be prevented from increasing, through memory sharing, and the memory usage increase occurring during the neural network operation may be prevented using the local memory.

Hereinafter, the structure of a neural network operation system in which various embodiments are implemented will be described with reference to FIGS. 2 and 3. In an embodiment, the system may be implemented in the form of SoC.

Referring to FIG. 2, according to an embodiment, the calculation unit that takes charge of calculation using software may be connected to a hardware configuration such as a hardware accelerator via a local bus.

The configuration of the electronic device illustrated in FIG. 2 is only an example and is variously changed to implement various embodiments disclosed in the disclosure. For example, the electronic device may include configurations the same as configurations such as the user terminal 401 illustrated in FIG. 4 and the electronic device 501 illustrated in FIG. 5 or may be properly changed using the configurations.

Referring to FIG. 2, the electronic device or a neural network operation system may include a memory 244 and a system on chip (SoC) 200 including an ISA core 212, a memory 214, at least one hardware accelerator 222-1, 222-2, . . . , or 222-N, a mesh network 224, an interface controller 226, a memory 228, a system bus 230, a memory controller 242, and the processor 250. In an embodiment, the ISA core 212 and/or the memory 214 may be implemented with a single chip (e.g., an application processor (AP) chip). In an embodiment, at least one hardware accelerator 222-1, 222-2, . . . , or 222-N, the mesh network 224, the interface controller 226, and/or the memory 228 may be implemented with a single chip (e.g., a neural network-dedicated chip).

In a function that each component performs, it may be understood that the ISA core 212, the memory 214, the at least one accelerator 222-1, 222-2, . . . , or 222-N, the mesh network 224, the interface controller 226, and the memory 228 of FIG. 2 correspond to the ISA core 112, the memory 114, the at least one accelerator 122-1, 122-2, . . . , or 122-N, the mesh network 124, the interface controller 126, and the memory 128 of FIG. 1, respectively. Hereinafter, the description of corresponding or redundant content will be omitted.

The part of functions of the ISA core 112 of FIG. 1 may be performed by the ISA core 212 and another part of the functions may be performed by the processor 250. In an embodiment, the ISA core 212 may make a request for calculation information of a hardware accelerator (e.g., 222-1) to the interface controller 226 via a local bus. In another embodiment, the processor 250 may make a request for calculation information of the hardware accelerator 222-1 to the interface controller 226 via the system bus 230. In an embodiment, the processor 250 may generate the meta data. In an embodiment, the processor 250 may perform determination on the input data, using calculation result of the ISA core 212 and/or at least one hardware accelerator 222-1, 222-2, . . . , or 222-N. In an embodiment, the processor 250 may generate control information about an external device or an internal device, using the calculation result.

An embodiment is exemplified in FIG. 2 as a processor is one. However, in an embodiment, the processor 250 may correspond to a plurality of processors. For example, the processor 250 may include CPU and/or GPU.

The interface controller 226 may control a process such as the sharing of data (e.g., calculation result) between the ISA core 212 and the at least hardware accelerator 222-1, 222-2, . . . , or 222-N, mutual access, or the like. For example, the interface controller 226 may convert a protocol or may control data transmission speed.

Referring to FIG. 2, according to an embodiment, a calculation unit (e.g., the ISA core 212 or the memory 214) that takes charge of calculation using software may be connected to a hardware configuration (e.g., the interface controller 226 or at least one hardware accelerator 222-1, 222-2, . . . , or 222-N) via a local bus. The data (e.g., the calculation result) stored in the memory 214 may be shared with a hardware accelerator (e.g., 222-1) at the request of the interface controller 226. The data stored in the memory 228 may be used in the ISA core 212 at the request of the interface controller 226. The ISA core 212 and the hardware accelerator 222-1 may share data with each other through the interface controller 226, using a local bus.

The system bus 230 may operate as a path for exchanging data. In an embodiment, the system bus 230 may transmit control information of the processor 250. The system bus 230 may transfer the information stored in the memory 244 to the ISA core 212 and/or the at least one hardware accelerator 222-1, 222-2, . . . , or 222-N. The system bus 230 may transfer the meta data according to an embodiment.

The memory controller 242 may manage data input or output by a memory. The memory controller 242 may be a DRAM controller.

The memory 244 may be a system memory. In an embodiment, the memory 244 may be a DRAM. The memory 244 may be connected to the SoC 200.

FIG. 3 illustrates a configuration of an electronic device or a neural network operation system, according to another embodiment.

Referring to FIG. 3, according to an embodiment, a calculation unit (e.g., an ISA core 312 of FIG. 3) that takes charge of calculation using software may be connected to a hardware configuration (e.g., a hardware accelerator 322-1) via a local bus or a system bus. In an embodiment, the ISA core 312 may be connected to the hardware accelerator (e.g., 322-1) via a system bus 330 without the local bus.

The configuration of the electronic device illustrated in FIG. 3 is only an example and is variously changed to implement various embodiments disclosed in the disclosure. For example, the electronic device may include configurations the same as configurations such as the user terminal 401 illustrated in FIG. 4, and the electronic device 501 illustrated in FIG. 5 or may be properly changed using the configurations.

Referring to FIG. 3, the electronic device or a neural network operation system may include a memory 344 and a SoC 300 including at least one of the ISA core 312, a memory 314, at least one hardware accelerator 322-1, 322-2, . . . , or 322-N, a mesh network 324, an interface controller 326, a memory 328, the system bus 330, a memory controller 342, and the processor 350.

In a function that each component performs, it may be understood that the ISA core 312, the memory 314, at least one accelerator 322-1, 322-2, . . . , or 322-N, the mesh network 324, the interface controller 326, the memory 328, the memory controller 342, the memory 344, and the processor 350 of FIG. 3 correspond to the ISA core 212, the memory 214, at least one accelerator 222-1, 222-2, . . . , or 222-N, the mesh network 224, the interface controller 226, the memory 228, the memory controller 242, the memory 244, and the processor 250 of FIG. 2, respectively. Hereinafter, the description of corresponding or redundant content will be omitted.

The part of functions of the ISA core 112 of FIG. 1 may be performed by the ISA core 312 of FIG. 3 and another part of the functions may be performed by the processor 350. In an embodiment, the ISA core 312 may make a request for calculation information of a hardware accelerator (e.g., 322-1) to the interface controller 326 via a local bus. In another embodiment, the processor 350 may make a request for calculation information of the hardware accelerator 322-1 to the interface controller 326 via the system bus 330.

An embodiment is exemplified in FIG. 3 as a processor is one. However, in an embodiment, the processor 350 may correspond to the at least one processor 350. The at least one processor may include a CPU and/or a GPU. In an embodiment, the processor 350 may perform profiling on at least one hardware accelerator 322-1, 322-2, . . . , or 322-N and may determine a calculation unit, which is suitable for input data, from among the ISA core 312 and the at least one hardware accelerator 322-1, 322-2, . . . , or 322-N. In an embodiment, the processor 350 may control the ISA core 312 via the system bus.

Referring to FIG. 3, according to an embodiment, a calculation unit (e.g., the ISA core 312 or the memory 314) performing calculation using software may be connected to the at least one hardware accelerator 322-1, 322-2, . . . , or 322-N, the interface controller 326, and/or the memory 328 via the local bus and/or the system bus. In an embodiment, the ISA core 312 may be connected to at least one hardware accelerator 322-1, 322-2, . . . , or 322-N, the interface controller 326, and/or the memory 328, using only the system bus. The data (e.g., the calculation result) stored in the memory 314 connected to the ISA core 312 may be shared with a hardware accelerator (e.g., 322-1) at the request of the interface controller 326. The data stored in the memory 328 may be used in the ISA core 312 at the request of the interface controller 326. The ISA core 312 and the hardware accelerator (e.g., 322-2) may share data with each other via the interface controller 326.

The system bus 330 may operate as a path for exchanging data. In an embodiment, the system bus 330 may be used to transmit data between the ISA core 312 and the interface controller 326. In an embodiment, the system bus 330 may transfer the calculation result of the ISA core 312 stored in the memory 314, to the interface controller 326.

The memory controller 342 may manage data input or output by the memory 344. The memory controller 342 may be a DRAM controller.

The memory 344 may be a system memory. In an embodiment, the memory 344 may be a DRAM. The memory 344 may be connected to SoC 300. In an embodiment, the memory 344 may be connected to a DRAM controller 342 included in the SoC 300.

Hereinafter, the described calculation operation of the electronic device of FIGS. 1 to 3 will be described based on the electronic device of FIG. 3.

In an embodiment, the electronic device may use two calculation resources (e.g., the ISA core 312 and the hardware accelerator (e.g., 322-1)) at the same time.

For example, the hardware accelerator may perform a simple calculation of a neural network, and the ISA core 312 may perform another calculation using information of the intermediate stage. In an embodiment, the electronic device may store the information of the intermediate stage in the calculation result of the hardware accelerator, in the memory 314. The ISA core 312 may use the information of the intermediate stage stored in the memory 314. The ISA core 312 may perform calculation or processing based on the information of the intermediate stage. The interface controller 326 may perform an operation according to an access protocol, to transfer the information of the intermediate stage to the ISA core 312 or the memory 314.

For another example, when two different neural networks need to be operated at the same time, the hardware accelerator (e.g., 322-1) and the ISA core 312 may operate each neural network. The hardware accelerator may operate a neural network associated with a simple calculation, and the ISA core 312 may operate a neural network that requires the large amount of control. The calculation suitable for the hardware accelerator may be determined by at least one of the ISA core 312, the interface controller 326, or the processor 350. The calculation suitable for the ISA core 312 may be determined by at least one of the ISA core 312, the interface controller 326, or the processor 350.

In another embodiment, the electronic device may use two calculation resources consecutively. When two neural networks are operated consecutively (e.g., when a single neural network operation result is used as an input to another neural network) the ISA core 312 and the hardware accelerator (e.g., 322-1) may be used consecutively. The output of the ISA core 312 may be the input of the hardware accelerator, or the output of the hardware accelerator may be the input of the ISA core 312.

According to various embodiments disclosed in the disclosure, according to an electronic device composed of an ISA core and a hardware accelerator or the operation of the electronic device, the neural network operation may be performed effectively. The ISA core may correspond to various neural network structures for each application field and may take charge of processing the information of the intermediate stage to increase the flexibility of calculation. The hardware accelerator may take charge of repetitive simple calculation or the like to improve energy efficiency.

FIG. 4 illustrates an electronic device in a network environment, according to various embodiments.

Referring to FIG. 4, according to various embodiments, an electronic device 401, a first electronic device 402, a second electronic device 404, or a server 406 may be connected each other over a network 462 or a short range communication 464. The electronic device 401 may include a bus 410, a processor 420, a memory 430, an input/output interface 450, a display 460, and a communication interface 470. According to an embodiment, the electronic device 401 may not include at least one of the above-described components or may further include other component(s).

For example, the bus 410 may interconnect the above-described components 410 to 470 and may include a circuit for conveying communications (e.g., a control message and/or data) among the above-described components.

The processor 420 may include one or more of a central processing unit (CPU), an application processor (AP), or a communication processor (CP). For example, the processor 420 may perform an arithmetic operation or data processing associated with control and/or communication of at least other components of the electronic device 401.

The memory 430 may include a volatile and/or nonvolatile memory. For example, the memory 430 may store commands or data associated with at least one other component(s) of the electronic device 401. According to an embodiment, the memory 430 may store software and/or a program 440. The program 440 may include, for example, a kernel 441, a middleware 443, an application programming interface (API) 445, and/or an application program (or “an application”) 447. At least a part of the kernel 441, the middleware 443, or the API 445 may be referred to as an “operating system (OS)”.

For example, the kernel 441 may control or manage system resources (e.g., the bus 410, the processor 420, the memory 430, and the like) that are used to execute operations or functions of other programs (e.g., the middleware 443, the API 445, and the application program 447). Furthermore, the kernel 441 may provide an interface that allows the middleware 443, the API 445, or the application program 447 to access discrete components of the electronic device 401 so as to control or manage system resources.

The middleware 443 may perform, for example, a mediation role such that the API 445 or the application program 447 communicates with the kernel 441 to exchange data.

Furthermore, the middleware 443 may process task requests received from the application program 447 according to a priority. For example, the middleware 443 may assign the priority, which makes it possible to use a system resource (e.g., the bus 410, the processor 420, the memory 430, or the like) of the electronic device 401, to at least one of the application program 447. For example, the middleware 443 may process the one or more task requests according to the priority assigned to the at least one, which makes it possible to perform scheduling or load balancing on the one or more task requests.

The API 445 may be, for example, an interface through which the application program 447 controls a function provided by the kernel 441 or the middleware 443, and may include, for example, at least one interface or function (e.g., an instruction) for a file control, a window control, image processing, a character control, or the like.

The input/output interface 450 may play a role, for example, of an interface which transmits a command or data input from a user or another external device, to other component(s) of the electronic device 401. Furthermore, the input/output interface 450 may output a command or data, received from other component(s) of the electronic device 401, to a user or another external device.

The display 460 may include, for example, a liquid crystal display (LCD), a light-emitting diode (LED) display, an organic LED (OLED) display, a microelectromechanical systems (MEMS) display, or an electronic paper display. The display 460 may display, for example, various contents (e.g., a text, an image, a video, an icon, a symbol, and the like) to a user. The display 460 may include a touch screen and may receive, for example, a touch, gesture, proximity, or hovering input using an electronic pen or a part of a user's body.

For example, the communication interface 470 may establish communication between the electronic device 401 and an external device (e.g., the first electronic device 402, the second electronic device 404, or the server 406). For example, the communication interface 470 may be connected to the network 462 over wireless communication or wired communication to communicate with the external device (e.g., the second electronic device 404 or the server 406).

The wireless communication may use at least one of, for example, long-term evolution (LTE), LTE Advanced (LTE-A), Code Division Multiple

Access (CDMA), Wideband CDMA (WCDMA), Universal Mobile Telecommunications System (UNITS), Wireless Broadband (WiBro), Global System for Mobile Communications (GSM), or the like, as cellular communication protocol. Furthermore, the wireless communication may include, for example, the short range communication 464. The short range communication 464 may include at least one of wireless fidelity (Wi-Fi), Bluetooth, near field communication (NFC), magnetic stripe transmission (MST), a global navigation satellite system (GNSS), or the like.

The MST may generate a pulse in response to transmission data using an electromagnetic signal, and the pulse may generate a magnetic field signal. The electronic device 401 may transfer the magnetic field signal to point of sale (POS), and the POS may detect the magnetic field signal using a MST reader. The POS may recover the data by converting the detected magnetic field signal to an electrical signal.

The GNSS may include at least one of, for example, a global positioning system (GPS), a global navigation satellite system (Glonass), a Beidou navigation satellite system (hereinafter referred to as “Beidou”), or an European global satellite-based navigation system (hereinafter referred to as “Galileo”) based on an available region, a bandwidth, or the like. Hereinafter, in the disclosure, “GPS” and “GNSS” may be interchangeably used. The wired communication may include at least one of, for example, a universal serial bus (USB), a high definition multimedia interface (HDMI), a recommended standard-232 (RS-232), a plain old telephone service (POTS), or the like. The network 462 may include at least one of telecommunications networks, for example, a computer network (e.g., LAN or WAN), an Internet, or a telephone network.

Each of the first and second electronic devices 402 and 404 may be a device of which the type is different from or the same as that of the electronic device 401. According to an embodiment, the server 406 may include a group of one or more servers. According to various embodiments, all or a portion of operations that the electronic device 401 will perform may be executed by another or plural electronic devices (e.g., the first electronic device 402, the second electronic device 404 or the server 406). According to an embodiment, in the case where the electronic device 401 executes any function or service automatically or in response to a request, the electronic device 401 may not perform the function or the service internally, but, alternatively additionally, it may request at least a portion of a function associated with the electronic device 401 from another device (e.g., the electronic device 402 or 404 or the server 406). The other electronic device may execute the requested function or additional function and may transmit the execution result to the electronic device 401. The electronic device 401 may provide the requested function or service using the received result or may additionally process the received result to provide the requested function or service. To this end, for example, cloud computing, distributed computing, or client-server computing may be used.

FIG. 5 illustrates a block diagram of an electronic device, according to various embodiments.

Referring to FIG. 5, an electronic device 501 may include, for example, all or a part of the electronic device 401 illustrated in FIG. 4. The electronic device 501 may include one or more processors (e.g., an application processor (AP)) 510, a communication module 520, a subscriber identification module 524, a memory 530, a sensor module 540, an input device 550, a display 560, an interface 570, an audio module 580, a camera module 591, a power management module 595, a battery 596, an indicator 597, and a motor 598.

The processor 510 may drive, for example, an operating system (OS) or an application to control a plurality of hardware or software components connected to the processor 510 and may process and compute a variety of data. For example, the processor 510 may be implemented with a System on Chip (SoC). According to an embodiment, the processor 510 may further include a graphic processing unit (GPU) and/or an image signal processor. The processor 510 may include at least a part (e.g., a cellular module 521) of components illustrated in FIG. 5. The processor 510 may load a command or data, which is received from at least one of other components (e.g., a nonvolatile memory), into a volatile memory and process the loaded command or data. The processor 510 may store a variety of data in the nonvolatile memory.

The communication module 520 may be configured the same as or similar to the communication interface 470 of FIG. 4. The communication module 520 may include the cellular module 521, a Wi-Fi module 522, a Bluetooth (BT) module 523, a GNSS module 524 (e.g., a GPS module, a Glonass module, a Beidou module, or a Galileo module), a near field communication (NFC) module 525, a MST module 526 and a radio frequency (RF) module 527.

The cellular module 521 may provide, for example, voice communication, video communication, a character service, an Internet service, or the like over a communication network. According to an embodiment, the cellular module 521 may perform discrimination and authentication of the electronic device 501 within a communication network by using the subscriber identification module (e.g., a SIM card) 529. According to an embodiment, the cellular module 521 may perform at least a portion of functions that the processor 510 provides. According to an embodiment, the cellular module 521 may include a communication processor (CP).

Each of the Wi-Fi module 522, the BT module 523, the GNSS module 524, the NFC module 525, or the MST module 526 may include a processor for processing data exchanged through a corresponding module, for example. According to an embodiment, at least a part (e.g., two or more) of the cellular module 521, the Wi-Fi module 522, the BT module 523, the GNSS module 524, the NFC module 525, or the MST module 526 may be included within one Integrated Circuit (IC) or an IC package.

For example, the RF module 527 may transmit and receive a communication signal (e.g., an RF signal). For example, the RF module 527 may include a transceiver, a power amplifier module (PAM), a frequency filter, a low noise amplifier (LNA), an antenna, or the like. According to another embodiment, at least one of the cellular module 521, the Wi-Fi module 522, the BT module 523, the GNSS module 524, the NFC module 525, or the MST module 526 may transmit and receive an RF signal through a separate RF module.

The subscriber identification module 529 may include, for example, a card and/or embedded SIM that includes a subscriber identification module and may include unique identify information (e.g., integrated circuit card identifier (ICCID)) or subscriber information (e.g., international mobile subscriber identity (IMSI)).

The memory 530 (e.g., the memory 430) may include an internal memory 532 or an external memory 534. For example, the internal memory 532 may include at least one of a volatile memory (e.g., a dynamic random access memory (DRAM), a static RAM (SRAM), a synchronous DRAM (SDRAM), or the like), a nonvolatile memory (e.g., a one-time programmable read only memory (OTPROM), a programmable ROM (PROM), an erasable and programmable ROM (EPROM), an electrically erasable and programmable ROM (EEPROM), a mask ROM, a flash ROM, a flash memory (e.g., a NAND flash memory or a NOR flash memory), or the like), a hard drive, or a solid state drive (SSD).

The external memory 534 may further include a flash drive such as compact flash (CF), secure digital (SD), micro secure digital (Micro-SD), mini secure digital (Mini-SD), extreme digital (xD), a multimedia card (MMC), a memory stick, or the like. The external memory 534 may be operatively and/or physically connected to the electronic device 501 through various interfaces.

A security module 536 may be a module that includes a storage space of which a security level is higher than that of the memory 530 and may be a circuit that guarantees safe data storage and a protected execution environment. The security module 536 may be implemented with a separate circuit and may include a separate processor. For example, the security module 536 may be in a smart chip or a secure digital (SD) card, which is removable, or may include an embedded secure element (eSE) embedded in a fixed chip of the electronic device 501. Furthermore, the security module 536 may operate based on an operating system (OS) that is different from the OS of the electronic device 501. For example, the security module 536 may operate based on java card open platform (JCOP) OS.

The sensor module 540 may measure, for example, a physical quantity or may detect an operation state of the electronic device 501. The sensor module 540 may convert the measured or detected information to an electric signal. For example, the sensor module 540 may include at least one of a gesture sensor 540A, a gyro sensor 540B, a barometric pressure sensor 540C, a magnetic sensor 540D, an acceleration sensor 540E, a grip sensor 540F, the proximity sensor 540G, a color sensor 540H (e.g., red, green, blue (RGB) sensor), a biometric sensor 5401, a temperature/humidity sensor 540J, an illuminance sensor 540K, or an UV sensor 540M. Although not illustrated, additionally or alternatively, the sensor module 540 may further include, for example, an E-nose sensor, an electromyography (EMG) sensor, an electroencephalogram (EEG) sensor, an electrocardiogram (ECG) sensor, an infrared (IR) sensor, an iris sensor, and/or a fingerprint sensor. The sensor module 540 may further include a control circuit for controlling at least one or more sensors included therein. According to an embodiment, the electronic device 501 may further include a processor that is a part of the processor 510 or independent of the processor 510 and is configured to control the sensor module 540. The processor may control the sensor module 540 while the processor 510 remains at a sleep state.

The input device 550 may include, for example, a touch panel 552, a (digital) pen sensor 554, a key 556, or an ultrasonic input unit 558. For example, the touch panel 552 may use at least one of capacitive, resistive, infrared and ultrasonic detecting methods. Also, the touch panel 552 may further include a control circuit. The touch panel 552 may further include a tactile layer to provide a tactile reaction to a user.

The (digital) pen sensor 554 may be, for example, a part of a touch panel or may include an additional sheet for recognition. The key 556 may include, for example, a physical button, an optical key, a keypad, or the like. The ultrasonic input device 558 may detect (or sense) an ultrasonic signal, which is generated from an input device, through a microphone (e.g., a microphone 588) and may check data corresponding to the detected ultrasonic signal. According to an embodiment, the touch panel 5352 may include a pressure sensor (or force sensor, interchangeably used hereinafter) that measures the intensity of touch pressure by a user. The pressure sensor may be implemented integrally with the touch panel 552, or may be implemented as at least one sensor separately from the touch panel 552.

The display 560 (e.g., the display 460) may include a panel 562, a hologram device 564, or a projector 566. The panel 562 may be the same as or similar to the display 460 illustrated in FIG. 4. The panel 562 may be implemented, for example, to be flexible, transparent or wearable. The panel 562 and the touch panel 552 may be integrated into a single module. The hologram device 564 may display a stereoscopic image in a space using a light interference phenomenon. The projector 566 may project light onto a screen so as to display an image. For example, the screen may be arranged in the inside or the outside of the electronic device 501. According to an embodiment, the display 560 may further include a control circuit for controlling the panel 562, the hologram device 564, or the projector 566.

The interface 570 may include, for example, a high-definition multimedia interface (HDMI) 572, a universal serial bus (USB) 574, an optical interface 576, or a D-subminiature (D-sub) 578. The interface 570 may be included, for example, in the communication interface 470 illustrated in FIG. 4. Additionally or alternatively, the interface 570 may include, for example, a mobile high definition link (MHL) interface, a SD card/multi-media card (MMC) interface, or an infrared data association (IrDA) standard interface.

The audio module 580 may convert a sound and an electric signal in dual directions. At least a component of the audio module 580 may be included, for example, in the input/output interface 450 illustrated in FIG. 4. The audio module 580 may process, for example, sound information that is input or output through a speaker 582, a receiver 584, an earphone 586, or the microphone 588.

For example, the camera module 591 may shoot a still image or a video. According to an embodiment, the camera module 591 may include at least one or more image sensors (e.g., a front sensor or a rear sensor), a lens, an image signal processor (ISP), or a flash (e.g., an LED or a xenon lamp).

The power management module 595 may manage, for example, power of the electronic device 501. According to an embodiment, a power management integrated circuit (PMIC), a charger IC, or a battery or fuel gauge may be included in the power management module 595. The PMIC may have a wired charging method and/or a wireless charging method. The wireless charging method may include, for example, a magnetic resonance method, a magnetic induction method or an electromagnetic method and may further include an additional circuit, for example, a coil loop, a resonant circuit, or a rectifier, and the like. The battery gauge may measure, for example, a remaining capacity of the battery 596 and a voltage, current or temperature thereof while the battery is charged. The battery 596 may include, for example, a rechargeable battery and/or a solar battery.

The indicator 597 may display a specific state of the electronic device 501 or a part thereof (e.g., the processor 510), such as a booting state, a message state, a charging state, and the like. The motor 598 may convert an electrical signal into a mechanical vibration and may generate the following effects: vibration, haptic, and the like. Although not illustrated, a processing device (e.g., a GPU) for supporting a mobile TV may be included in the electronic device 501. The processing device for supporting the mobile TV may process media data according to the standards of digital multimedia broadcasting (DMB), digital video broadcasting (DVB), MediaFlo™, or the like.

Each of the above-mentioned components of the electronic device according to various embodiments of the disclosure may be configured with one or more parts, and the names of the components may be changed according to the type of the electronic device. In various embodiments, the electronic device may include at least one of the above-mentioned components, and some components may be omitted or other additional components may be added. Furthermore, some of the components of the electronic device according to various embodiments may be combined with each other so as to form one entity, so that the functions of the components may be performed in the same manner as before the combination.

The term “module” used in the disclosure may represent, for example, a unit including one or more combinations of hardware, software and firmware. The term “module” may be interchangeably used with the terms “unit”, “logic”, “logical block”, “part” and “circuit”. The “module” may be a minimum unit of an integrated part or may be a part thereof. The “module” may be a minimum unit for performing one or more functions or a part thereof. The “module” may be implemented mechanically or electronically. For example, the “module” may include at least one of an application-specific IC (ASIC) chip, a field-programmable gate array (FPGA), and a programmable-logic device for performing some operations, which are known or will be developed.

At least a part of an apparatus (e.g., modules or functions thereof) or a method (e.g., operations) according to various embodiments may be, for example, implemented by instructions stored in a computer-readable storage media in the form of a program module. The instruction, when executed by a processor (e.g., the processor 420), may cause the one or more processors to perform a function corresponding to the instruction. The computer-readable storage media, for example, may be the memory 430.

A computer-readable recording medium may include a hard disk, a floppy disk, a magnetic media (e.g., a magnetic tape), an optical media (e.g., a compact disc read only memory (CD-ROM) and a digital versatile disc (DVD), a magneto-optical media (e.g., a floptical disk)), and hardware devices (e.g., a read only memory (ROM), a random access memory (RAM), or a flash memory). Also, the one or more instructions may contain a code made by a compiler or a code executable by an interpreter. The above hardware unit may be configured to operate via one or more software modules for performing an operation according to various embodiments, and vice versa.

A module or a program module according to various embodiments may include at least one of the above components, or a part of the above components may be omitted, or additional other components may be further included. Operations performed by a module, a program module, or other components according to various embodiments may be executed sequentially, in parallel, repeatedly, or in a heuristic method. In addition, some operations may be executed in different sequences or may be omitted. Alternatively, other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

1. An electronic device comprising:
a first calculation unit configured to perform one neural network operation of a plurality of neural network operations;
a second calculation unit including a hardware accelerator configured to perform a specified neural network operation; and
an interface controller connected between the first calculation unit and the second calculation unit.

2. The electronic device of claim 1, wherein the first calculation unit and the interface controller are connected via a local bus.

3. The electronic device of claim 1, wherein the first calculation unit includes:
a core configured to perform a neural network operation depending on instructions; and
a first memory configured to store a neural network operation result of the core, and
wherein the second calculation unit is connected to a second memory configured to store a neural network operation result of the hardware accelerator.

4. The electronic device of claim 3, wherein the interface controller is connected to the second memory and the second calculation unit.

5. The electronic device of claim 1, wherein the first calculation unit or the interface controller is configured to:
obtain input data; and
determine a calculation unit performing a neural network operation on the input data among the first calculation unit or the second calculation unit.

6. The electronic device of claim 3, wherein the second calculation unit is configured to:
refer to information stored in the first memory via the interface controller.

7. The electronic device of claim 3, wherein the second calculation unit is configured to:
refer to information stored in the first memory via the interface controller.

8. The electronic device of claim 3, wherein the interface controller allows a calculation result of the first calculation unit or the second calculation unit to be stored in a memory where memory space remains, among the first memory or the second memory.

9. The electronic device of claim 3, wherein a neural network operation result of the first calculation unit includes at least one of a calculation result of a hidden layer or a calculation result of an output layer of a neural network, and
wherein a neural network operation result of the second calculation unit includes at least one of a calculation result of a hidden layer or the calculation result of the output layer of a neural network, and

10. The electronic device of claim 3, wherein the interface controller is connected to the second calculation unit and the second memory via a local bus.

11. An electronic device comprising:
a system on chip (SoC); and
a first memory electrically connected to the SoC, wherein the SoC includes:
at least one processor;
a core configured to perform one neural network operation of a plurality of neural network operations;
a hardware accelerator configured to perform a specified neural network operation;
a second memory for storing a neural network operation result of the core;
a third memory for storing a neural network operation result of the hardware accelerator; and
an interface controller connected between the second memory and the third memory.

12. The electronic device of claim 11, wherein the first memory includes a dynamic random access memory (DRAM), and
wherein the SoC further includes a DRAM controller.

13. The electronic device of claim 11, wherein the second memory and the third memory are connected via a local bus.

14. The electronic device of claim 11, wherein the second memory and the third memory are a static random access memory (SRAM).

15. The electronic device of claim 11, wherein the at least one processor and the core are connected via a system bus.
